(19) United States
(12) Patent Application Publication
(10) Pub. No.: US 2026/0252928 A1
(43) Pub. Date: Aug. 27, 2026

(54) Method and Apparatus for Data Processing

(71) Applicant: Huawei Cloud Computing Technologies Co., Ltd., Guizhou (CN)

(72) Inventors: Elena Pavlovna Bruches, Moscow (RU); Pavel Petrochenko, Novosibirsk (RU); Alexey Ratushnii, Moscow (RU)

(73) Assignee: Huawei Cloud Computing Technologies Co., Ltd., Guizhou (CN)

(21) Appl. No.: 19/657,779

(22) Filed: Apr. 24, 2026

Related U.S. Application Data
(63) Continuation of application No. PCT/RU2024/000095, filed on Mar. 22, 2024.

(30) Foreign Application Priority Data
Oct. 27, 2023 (WO) PCT/RU2023/000329

(51) Int. Cl. G06N 7/01; G06F 40/40

(52) U.S. Cl. CPC G06N 7/01; G06F 40/40

(57) ABSTRACT

A method for data processing includes obtaining data from a user; obtaining a probabilistic knowledge graph (PKG), where facts in the PKG are assigned with probabilities, and domain of the data is the same as domain of the PKG; and obtaining a first output result based on the data, the PKG and a language model, where the language model is configured to perform a natural language processing (NLP) task.

### CROSS-REFERENCE TO RELATED APPLICATIONS

This is a continuation of International Patent Application No. PCT/RU2024/000095 filed on Mar. 22, 2024, which claims priority to International Patent Application No. PCT/RU2023/000329 filed on Oct. 27, 2023, all of which are hereby incorporated by reference.

### TECHNICAL FIELD

Embodiments of the present application relate to the field of natural language processing (NLP), and in particular, to a method and apparatus for data processing.

### BACKGROUND

Language models (LMs) are the most prominent research area nowadays, especially large language models (LLMs), which exhibit strong capacities to understand natural language and solve complex tasks. Although LLMs have made a significant breakthrough in many NLP tasks and beyond, there are still some limitations in terms of performance. Combining knowledge graphs (KGs) with LMs is a promising research direction as some of the problems that arise in LMs may be resolved to some extent by using KGs. However, it is difficult to create high-quality KGs, which may affect the quality of NLP down-stream tasks.

Therefore, an urgent technical problem that needs to be solved is how to improve the quality of NLP down-stream tasks.

### SUMMARY

Embodiments of the present application provide a method and apparatus for data processing. The technical solutions may improve the quality of NLP down-stream tasks.

According to a first aspect, an embodiment of the present application provides a method for data processing, including obtaining data from a user, obtaining a probabilistic knowledge graph (PKG), where facts in the PKG are assigned with probabilities, and domain of the data is the same as domain of the PKG, and obtaining a first output result based on the data, the PKG and a language model, where the language model is configured to perform an NLP task.

According to the above technical solution, the information from the PKG of the same domain as the data can be used to enhance the performance of the language model. Probabilities for the facts in PKG smooth the information and may change depending on the task or context, which is beneficial to ensuring the accuracy of information in PKG in different scenarios, thereby improving the performance of the language model and ensuring the quality of NLP down-stream tasks.

Meanwhile, the information that the language model can use to output results is not only encoded in the language model's weights, but also stored in the PKG, which is an external structure. The externally stored information, namely the information in PKG, is beneficial for improving the quality of NLP down-stream tasks without increasing the size of the language model. Compared to language models that only include text data as input, the technical solutions in the embodiments of the present application may achieve better performance with a smaller language model size.

The data from a user may also refer to the data to be processed in the NLP task.

For example, the data to be processed may be text data to be processed or voice data to be processed.

In a possible design, the method further includes modifying the PKG after obtaining the first output result.

Optionally, modifying the PKG may include at least one of the following: adding one or more new facts to the PKG, modifying one or more existing facts in the PKG, or removing one or more existing facts in the PKG.

According to the above technical solution, the modifications in PKG can be used for the language model's predictions. Information is stored explicitly in the PKG. It is relatively easy to find the needed information in PKG and validate it. In this way, the output from the language model can be controlled without retraining again. This greatly reduces the waiting time for users, which is beneficial for improving the user experience. At the same time, it is beneficial to avoid the large-scale occupation of resources caused by retraining.

In a possible design, the modifying the PKG after obtaining the first output result includes obtaining a modification to the PKG that is input through a public application programming interface, and applying the modification to the PKG.

According to the above technical solution, the API allows the user to modify the information in the PKG explicitly. In this way, the user may correct the results or get desired results by modifying the information in the PKG, which is beneficial for improving the user experience.

In a possible design, the method further includes obtaining a second output result based on the data, a modified PKG and the language model.

According to the above technical solution, the language model may output new results with the same data to be processed almost immediately. This greatly reduces the waiting time for users, which is beneficial for improving the user experience. At the same time, it is beneficial to avoid the large-scale occupation of resources caused by retraining.

In a possible design, the method further includes encoding the data to be processed to obtain second embeddings. The obtaining a first output result based on the data, the PKG and a language model includes obtaining the first output result based on the second embeddings, the PKG and the language model.

In a possible design, the method further includes encoding one or more facts in the PKG to obtain first embeddings. The obtaining a first output result based on the data, the PKG and a language model includes obtaining the first output result based on the data, the first embeddings and the language model.

The one or more facts in the PKG may be part or all of the facts in the PKG.

In a Possible Design, the One or More Facts are Determined According to Cosine Similarity Between Strings from the Data and Entities in the PKG.

Optionally, cosine similarity between the string from the text data and the entities may be used to determine the one or more facts.

In a possible design, the method further includes encoding the data to be processed to obtain second embeddings, and encoding one or more facts in the PKG to obtain first embeddings. The obtaining a first output result based on the data, the PKG and a language model includes inputting the second embeddings and the first embeddings into the language model to obtain the first output result.

In a possible design, the obtaining a first output result based on the data, the PKG and a language model includes concatenating the second embeddings and the first embeddings, and inputting the concatenated result into the language model to obtain the first output result, or inputting the second embeddings and the first embeddings separately into the language model to obtain the first output result.

According to a second aspect, an embodiment of the present application provides an apparatus for data processing, including a first obtaining module configured to obtain data from a user, a second obtaining module configured to obtain a PKG, where facts in the PKG are assigned with probabilities, and domain of the data is the same as domain of the PKG, and a third obtaining module configured to obtain a first output result based on the data, the PKG and a language model, where the language model is configured to perform an NLP task.

In a possible design, the apparatus further includes a modification module configured to modify the PKG after obtaining the first output result.

In a possible design, the modification module is configured to obtain a modification through a public application programming interface, and apply the modification to the PKG.

In a possible design, the third obtaining module is further configured to obtain a second output result based on the data, a modified PKG and the language model.

In a possible design, the apparatus further includes a first encoding module configured to encode one or more facts in the PKG to obtain first embeddings. The third obtaining module is configured to obtain the first output result based on the data, the first embeddings and the language model.

In a possible design, the one or more facts are determined according to cosine similarity between strings from the data and entities in the PKG.

In a possible design, the apparatus further includes a second encoding module configured to encode the data to obtain second embeddings. The third obtaining module is configured to concatenate the second embeddings and the first embeddings, and input the concatenated result into the language model to obtain the first output result, or input the second embeddings and the first embeddings separately into the language model to obtain the first output result.

According to a third aspect, a computing device cluster is provided, including at least one computing device, each computing device includes a processor and a memory. The processor of the at least one computing device is configured to execute instructions stored in the memory of the at least one computing device, so that the computing device cluster performs the method in any one of the first aspect or the possible designs of the first aspect.

According to a fourth aspect, a computer-readable storage medium is provided, including one or more instructions. When the one or more instructions are executed by a computing device cluster, the computing device cluster performs the method in any one of the first aspect or the possible designs of the first aspect.

According to a fifth aspect, a computer program product including instructions is provided, where when the instructions are executed by a computing device cluster, the computing device cluster performs the method in any one of the first aspect or the possible designs of the first aspect.

### DESCRIPTION OF DRAWINGS

FIG. 1A is a schematic diagram of an example of KG and FIG. 1B is a schematic diagram of an example of PKG;

FIG. 2 is a schematic diagram of a system architecture according to an embodiment of the present application;

FIG. 3 is a schematic flowchart of a method for data processing according to an embodiment of the present application;

FIG. 4 is a schematic flowchart of another method for data processing according to an embodiment of the present application;

FIG. 5 is schematic diagram of an example input for the first language model according to an embodiment of the present application;

FIG. 6 is schematic flowchart of a training method for a language model according to an embodiment of the present application; and

FIGS. 7-10 are schematic block diagrams of possible devices according to embodiments of the present application.

### DESCRIPTION OF EMBODIMENTS

The following describes technical solutions of the present application with reference to the accompanying drawings.

The embodiments of the present disclosure may be applied to NLP tasks. For example, the NLP tasks may include machine translation, question-answering (QA) tasks, sentiment analysis, and text summarization extraction, or the like.

In order to facilitate understanding of the embodiments of the present application, terms related to artificial intelligence (AI)/machine learning (ML) that may be involved in the embodiments of the present application are described below.

### (1) Lm:

Language modeling aims to model the generative likelihood of word sequences, so as to predict the probabilities of future (or missing) tokens.

Development of language models started from statistical language models, based on the Markov assumption, e.g., predicting the next word based on the most recent context.

Further neural language models were proposed to obtain the probability of word sequences by neural networks, e.g. word to vector (Word2Vec).

Next pre-trained language models (PLM) were introduced. For example, embedding from language models (ELMo) was proposed to capture context-aware word representations using a bidirectional long short-term memory (biLSTM) network instead of learning fixed word representations. Another model is bidirectional encoder representations from transformers (BERT), based on the highly parallelizable Transformer architecture with self-attention mechanisms.

Scaling PLM (e.g., scaling model size or data size) often leads to an improved model capacity on down-stream tasks. The LLMs refer to Transformer language models that contain hundreds of billions (or more) of parameters, which are trained on massive text data, such as generative pre-trained transformer (GPT)-3, Galactica, etc.

LLMs exhibit strong capacities to understand natural language and solve complex tasks (via text generation).

### (2) KG:

KGs have emerged as a compelling abstraction for organizing the world's structured knowledge, and as a way to integrate information extracted from multiple data sources.

KG is defined as a directed, multi-relational graph where entities (nodes) are connected with one or more relations (edges). Anything can act as a node, for example, people, company, computer, etc. An edge label captures the relationship of interest between the nodes, for example, a friendship relationship between two people, a customer relationship between a company and person, or a network connection between two computers, etc.

KG serves as a data structure in which an application stores information. The information could be added to the knowledge graph through a combination of human input, automated and semi-automated methods. Regardless of the method of knowledge entry, it is expected that the recorded information can be easily understood and verified by humans.

The most popular KGs include DBpedia, Freebase, Wikidata, YAGO, etc.

### (3) Probabilistic Knowledge Graph (PKG):

PKG is called a KG, in which each edge has the pre-defined probability. For example, a fact may be represented as follows:
<head entity, relation, tail entity, probability>.

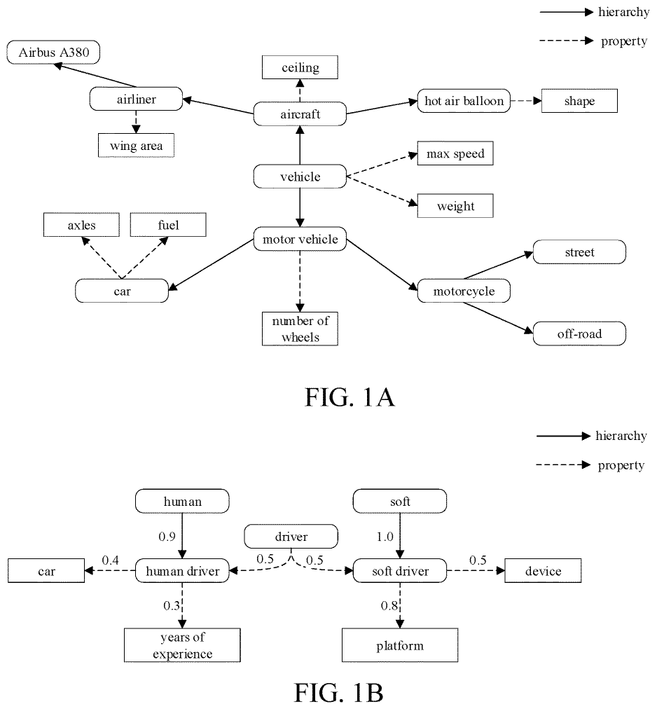

FIGS. 1A and 1B shows an example of KG and an example of PKG.

There are two types of relations in the KG and the PKG shown in FIGS. 1A and 1B, namely hierarchy and property.

One hierarchy relation is taken as an example. For example, there is an edge indicating a hierarchy relation between the vertex “vehicle” and the vertex “motor vehicle” in FIG. 1A, which means the vehicle includes the motor device.

One property relation is taken as an example. For example, there is an edge indicating a property relation between the vertex “car” and the vertex “fuel” in FIG. 1A, which means the fuel is a property of the car.

Compared to the KG shown in FIG. 1A, the edges in the PKG shown in FIG. 1B have been assigned with probabilities.

One hierarchy relation is taken as an example. For example, there is an edge with a probability of 0.9 that indicates the hierarchy relation between the vertex “human” and the vertex “human driver” in FIG. 1B, which means that the probability of human including human driver is 0.9.

Unlike taxonomies that treat knowledge as black and white, PKG uses probabilities to model inconsistent, ambiguous and uncertain information it contains.

### (4) AI/ML Model Training:

AI/ML model training is a process to train an AI/ML Model by learning the input/output relationship in a data driven manner and obtain the trained AI/ML Model for inference.

### (5) AI/ML Model Inference:

AI/ML model inference is a process of using a trained AI/ML model to produce a set of outputs based on a set of inputs.

### (6) Supervised Learning:

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

Language models are the most prominent research area nowadays, especially LLMS, which have made a significant breakthrough in many NLP tasks and beyond, but there are still some limitations and drawbacks as follows.
(1) LLMs are shown to suffer from a lack of consistency in their answers. For example, they can provide different results when queried for the same fact but under different wording.
(2) It can be difficult to follow the path of the LLM reasoning.

Some of the problems that arise in LMs mentioned above may be resolved to some extent by using KGs. For example, structured KGs are built with consistency in mind. Several efficient algorithms have been proposed to detect inconsistencies in KGs, in which case such conflicts may be resolved. For another example, in a KG, it can be simple to follow the path of reasoning. Output from KGs can be easily inferred, so they are quite interpretable and explainable.

The approaches to combine LMs and KGs can be divided into the following categories.
(1) Input injections: modifying the structure of the input or the data that is selected to be fed into the language models.

Examples: Align, Mask, Select (AMS) and COMmonsEnse transformers (COMET).

AMS proposes a pre-training approach that can leverage commonsense KGs to improve the commonsense reasoning capability of language representation models, such as BERT, without sacrificing the language representation capabilities of the models.
(2) Architecture injections: adding additional layers that integrate knowledge in some way with the contextual representations or modifying existing layers to manipulate things.

Examples: knowledge enhanced contextual word representations (KnowBERT) and Common sense or world knowledge.

KnowBERT first uses an integrated entity linker to retrieve relevant entity embeddings, then updates contextual word representations via a form of word-to-entity attention.

Common sense or world knowledge uses adapter-based training, which injects additional parameters into the encoder and only tunes their values while keeping the original transformer parameters fixed.
(3) Output injections: changing the output structure or the losses that were used in the base model in some way to incorporate knowledge.

Example: semantics-aware BERT (SemBERT). SemBERT incorporates explicit contextual semantics from pre-trained semantic role labeling.
(4) Combination and hybrid injections: combinations of injection types such as input/output injections or architecture/output injections.

Examples: knowledge-augmented language model (KALM), BERT-based language model integrated with medical knowledge (BERT-MK) and BERT for knowledge graph completion (KG-BERT).

KALM modifies the input of the model by fusing entity embeddings with the normal word embeddings, also, it enforces the model in the output to uphold the entity information by adding an additional loss component in the pre-training.

BERT-MK utilizes a modified attention mechanism to mimic the KG structure between terms and incorporates triple reconstruction loss to train the KG-transformer modules.

KG-BERT fine tunes BERT into completing triples from a KG, uses a binary classification to predict if a triple is valid, and uses multi-class classification to predict relation type.

Moreover, there is a trend to create frameworks which can modify the models to affect the results.

Combining KGs with LMs is a promising research direction as it may improve the NLP down-stream task quality. However, it is difficult to create high quality KGs, which may affect the down-stream task quality. It cannot guarantee that KGs eliminate all errors and mistakes. Moreover, some facts may be true or false depending on different contexts and situations.

The embodiment of the present application provides a technical solution for enhancing language models with probabilistic information, which is beneficial to improving the quality of the NLP down-stream tasks.

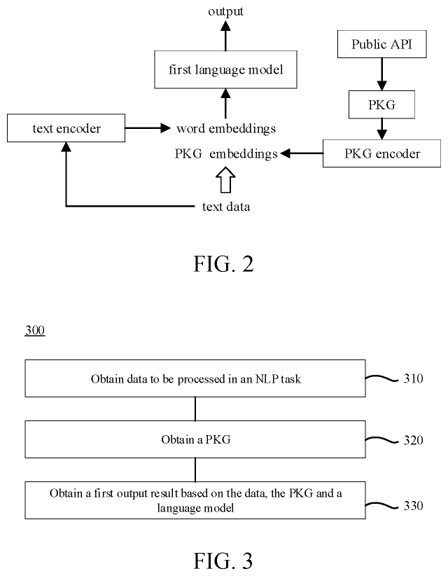

FIG. 2 illustrates a schematic diagram of a system architecture in an embodiment of the present application.

As shown in FIG. 2, a system architecture may include a PKG and a first language model.

Facts with probabilities are stored in PKG.

The first language model is used to deal with an NLP task. Further, the first language model may be used to provide an output based on the data to be processed in the NLP task and the PKG.

The “first” in the “first language model” is only used to illustrate that the first language model is a trained language model or a language model that can be used for inference and does not have any other limiting effect.

The NLP task may also be called NLP down-stream task.

The input of the first language model may be obtained from text data and PKG.

The text data and PKG may be input into the first language model in a proper form.

For example, as shown in FIG. 2, the input of the first language model may include text embeddings and PKG embeddings.

The text embeddings may be obtained by encoding the text data. The model used to encode the text data may be called a text encoder. The text encoder may belong to the system 200. Or the text encoder may not belong to the system 200.

The PKG embeddings may be obtained by encoding the PKG. The model used to encode the PKG may be called a PKG encoder. The PKG encoder may belong to the system architecture. Or the PKG encoder may not belong to the system architecture.

Further, optionally, the system architecture may also include public application programming interface (API) for editing PKG. The public API allows the users to modify the information in the PKG explicitly.

The system architecture is general and applicable to any NLP down-stream tasks.

The details about the system 200 can refer to method 300 in the following text, and will not be described here.

FIG. 3 is a schematic flowchart of a method 300 for data processing. The method 300 can be applied to the language model inference. The language model's input is augmented with information from PKG.

For example, the method 300 may be performed by the system 200.

As shown in FIG. 3, the method 300 may include the following steps.
310, obtain data to be processed in an NLP task.
320, obtain a PKG. Facts in the PKG are assigned with probabilities. The domain of the data to be processed is the same as domain of the PKG.
330, obtain a first output result based on the data, the PKG and a language model. The language model is configured to perform the NLP task.

For example, the data to be processed may be text data to be processed or voice data to be processed. For the sake of convenience, the text data is taken as an example for explanation in the embodiment of the present application, and does not limit the technical solutions in the embodiment of the present application.

The information, such as context, from the text data, is crucial for any NLP down-stream task, in which case a language model needs to process the task based on the information from the text data. In other words, the information from the text data needs to be fed into the language model.

The language model in step 330 a trained language model or a language model that can be used for inference.

The language model in step 330 may be a task model, which is used to output the processing results of a specific NLP task.

The language model in step 330 may be any type of language model. For example, the language model in step 330 may be an LLM.

In the embodiments of the present application, an NLP down-stream task can also be called an NLP task or a down-stream task.

Step 330 may also be understood in the following way. The language model provides the first output result based on the information from the data to be processed and information from the PKG.

For ease of description, in method 300, the information from the data to be processed may be referred to as the first data, and the information from PKG may be referred to as second data. For example, the first data and the second data may be input into the language model to obtain the first output result.

The information from the text data may be named text information.

The first data may be the representation of the text data. The form of the first data depends on the language model's requirements for the form of input. Different language models may require different forms of input, and correspondingly, the form of the first data may also be different.

In some embodiments, the first data may be obtained by encoding the text data.

Exemplarily, the input form of the language model may be the encoding result of text data. For text data, it needs to be encoded before it can be input into the language model. For example, the language model may be the first language model in FIG. 2.

The model used to encode the text data can be called a text encoder.

For example, the first data may be word embeddings (an example of the second embeddings), which means the text data may be represented via the word embeddings.

In other words, the method 300 may also include encoding the data to be processed to obtain corresponding embeddings, i.e. second embeddings, which may serve as the first data. In this case, the data to be processed in step 330 may be replaced with the second embeddings.

The text data may be encoded through many algorithms and models, such as global vectors for word representation (GloVe), Word2Vec, FastText, ELMo, BERT, etc. The model used to encode the text to obtain the word embeddings can also be called a word embeddings model. The word embeddings model belongs to the text encoder shown in FIG. 2.

In addition, other models or algorithms that can encode text data can also be used in the embodiments of the present application.

The word embeddings may also be called text embeddings.

The first data may also be other features of the text data.

In some embodiments, the first data may be the text data.

For example, the text data may be directly fed into the language model.

The language model may encode the text data, and then perform subsequent processing on the encoding results.

For example, the language model may include a sub model for encoding text, such as GloVe, Word2Vec, FastText, ElMo, BERT, etc. FIG. 2 is taken as an example. The language model may include the first language model and the text encoder in FIG. 2.

The forms of the first data mentioned above are merely examples. The embodiments of the present application do not limit the representation form of the first data.

The “first” in the “first data” is only used to illustrate that the first data is based on the data to be processed and does not have any other limiting effect. For example, the text data input into the language model, or the encoding result of the text data input into the language model, can be considered as the first data.

The language model in step 330 may be applied to NLP task #1. The data in step 310 may be understood as the data to be processed in the NLP task #1.

Exemplarily, the data to be processed may be obtained from a user. In this case, the step 310 may include obtaining data from a user.

Text data is taken as an example. The user may input the text data. The language model may output the NLP result corresponding to the text data.

For example, the NLP task #1 may be a question-answering task. The user may input a question (an example of the text data). The language model may output the answer to the question.

Alternatively, the data to be processed may be received from other device(s).

The facts in the PKG are assigned with probabilities. In other words, the edges in the PKG carry the probabilistic information.

The PKG may be created from a raw source.

For example, the raw source may be raw texts or raw documents.

The raw source may be from a common domain or a specific domain. A specific domain may be referred to as a particular domain. A PKG created based on the raw source from a common domain can be called a domain-general PKG. A PKG created based on the raw source from a specific domain can be called a domain-specific PKG.

Exemplarily, for an open-domain task to be solved by an open-domain system, a domain-general PKG containing the information about the world may be more suitable, while for a close-domain task to be solved by a close-domain system, a domain-specific PKG containing the information related to this particular domain may be more suitable.

QA task is taken as an example. QA can be divided into close-domain QA and open-domain QA.

The open-domain QA may be used for answering any factual question, while the close-domain QA is generally limited to a specific field and has a given knowledge base in that field. For example, a question-answering robot in a hospital may be only responsible for answering medical related questions, and even only responsible for answering explanatory questions about this hospital. For another example, chat-bots for banking may be only used for financial services.

The PKG in step 320 may be a domain-general PKG or a domain-specific PKG depending on the field where the language model is applied or the field of the task to be solved by the language model.

If the language model is applied to an open-domain system, the PKG in step 320 may be a domain-general PKG. For example, an open-domain system may be an open-domain question-answering system, a chat bot, named entity recognition, summarization, etc. In this case, the richer the general information about the world in the PKG, the better the language model may handle the tasks. If the language model is applied to a close-domain system, the PKG in step 320 may be a domain-specific PKG. In this case, there is no need to use the general information about the world, but the task quality may benefit from the usage of domain-specific facts. For example, a close-domain system may be chat-bot for banking. For another example, a close-domain system may be used for named entity recognition from the legal documents. For another example, a close-domain system may be a programming assistant in software tools development. The above is only an example, the PKG may be adapted to other particular areas such as marketing, e-commerce, etc.

The domain-general PKG is taken as an example.

For example, the PKG in step 320 may be created based on the Wikipedia category tree, where facts with IS-A relation (hyperonymy) are saved. The probability of a fact may be obtained from a language mode that assigns probability to the pattern “A is B”, where A and B are a subject and an object in the fact, respectively. As a result, a PKG with needed information can be created, in which case the needed information is the general type of information.

For another example, the PKG in step 320 may be a specialized PKG, which may include IS-A relation and other semantic relations, such as locations, temporal relations, interpersonal relation, etc. The other semantic relations may be acquired from a large number of raw texts or documents, such as the Wikipedia articles, using information extraction techniques and algorithms. In this case, the PKG is enriched with a large amount of semantic information, which means the PKG may be more accurate. The probabilities of the facts may be obtained based on the entities joint cooccurrence in the raw texts or documents.

The domain-specific PKG is taken as an example.

The PKG in step 320 may be created from the scope of the raw documents related to a specific field. For example, the language model may be used for named entity recognition from the legal documents. The PKG may be created from the scope of the raw documents related to the legal field. The PKG may contain only specific types of entities and semantic relations related to this domain.

The above is only an example and does not constitute a limitation on PKG used in the embodiments of the present application.

The PKG in step 320 may be pre-created and stored.

The information from the PKG may be named PKG information.

The information from the PKG may be understood as the information from the facts in the PKG.

The second data is the representation of the PKG. The form of the second data depends on the language model's requirements for the form of input. Different language models may require different forms of input, and correspondingly, the form of the second data may also be different.

In some embodiments, the second data may be obtained by encoding the PKG.

Exemplarily, the input form of the language model may be the encoding result of the PKG. For the PKG, it needs to be encoded before it can be input into the language model. For example, the language model may be the first language model in FIG. 2.

Encoding the PKG may include encoding one or more facts in the PKG.

The PKG may be encoded in a proper form for the input of the language model, e.g. in a continuous representation.

For example, the method 300 may also include encoding the one or more facts to obtain corresponding embeddings, i.e. first embeddings, which may serve as the second data. In this case, the PKG in step 330 may be replaced with the first embeddings.

The corresponding embeddings may also be called PKG embeddings, which means the PKG may be represented via embeddings. The PKG embeddings may be continuous vectors.

The one or more facts in the PKG may be part or all of the facts in the PKG. In other words, the second data may be obtained by encoding part or all of the facts in the PKG.

The encoding may be done in a plurality of ways.

Exemplarily, entities in the one or more facts may be encoded to vectors, i.e. entity embeddings.

Alternatively, relations in the one or more facts may be encoded to vectors, i.e. relation embeddings.

Alternatively, triples with assigned probabilities in the one or more facts may be encoded to vectors, i.e. triple embeddings.

A triple with assigned probability may be represented as: <head entity, relation, tail entity, probability>.

In the embodiment of the present application, the information from PKG is introduced into the processing process of the language model, so that the edge probabilities can be taken into account.

The PKG may be encoded through many algorithms and models, such as fastnode2vec, translating embeddings (TransE), RotatE, pRotatE, complex embedding (ComplEx), DistMult, etc.

The model used to encode the PKG may be the PKG encoder shown in FIG. 2.

In addition, other models or algorithms that can encode a PKG can also be used in the embodiments of the present application.

The “second” in the “second data” is only used to illustrate that the second data is based on the PKG and does not have any other limiting effect.

The one or more facts may be the facts related to the text data in the PKG.

In some cases, each concept in the text data may be encoded into a word embedding and a PKG embedding. A concept may include one or more words.

For example, as shown in FIG. 5, the text data may be a sentence “A cat sat on the mat”. The one or more facts may be the facts related to the sentence. Each concept may be a word. Each word may be encoded into a word embedding and a PKG embedding.

For another example, a concept may be a phase, which means that multiple words in the phrase are encoded to obtain a word embedding and a PKG embedding. A phase “New Year” is taken as an example. The phase may be encoded as a complete concept, rather than distinct words “New” and “Year”.

The facts are stored in the specific location in the PKG, but finding the needed facts can be a challenging task depending on the size of the PKG.

Similarity between string which is from the text data and the entities in the PKG may be used to determine the one or more facts.

Optionally, cosine similarity between the string from the text data and the entities may be used to determine the one or more facts.

Further, cosine similarity between the string from the text data and the entities along with their parents may be used to determine the one or more facts.

Further, to search the most appropriate triple or fact for a string, not only the exact string matching can be considered, but also the use of the mistakes, synonyms and other rephrasing techniques can be considered for search.

Further, the context may be considered while searching for the facts. The context may include local context from the text data and global context. The global context may be related to a particular domain, situation, etc. Or the global context may be from a common domain. The global context may be encoded via text classification tasks (to define topic, sentiment, etc.) or via learning more sophisticated embeddings.

The above is only an example. Other methods used to determine the facts related to the text data can also be used in the embodiments of the present application.

In some embodiments, the second data may include one or more subgraphs of the PKG.

For example, the one or more subgraphs may be directly fed into the language model.

In some cases, the PKG can be considered as its own subgraph. In other words, the second data may be the PKG.

The language model may encode the one or more subgraphs, and then perform subsequent processing on the encoded results.

For example, the language model may include a sub model for encoding the one or more subgraphs, such as fastnode2vec, TransE, RotatE, pRotatE, ComplEx, DistMult, etc. FIG. 2 is taken as an example. The language model may include the first language model and the PKG encoder in FIG. 2.

The forms of the second data mentioned above are merely examples. The present embodiments do not limit the representation form of the PKG.

Compared to a language model that only uses text data as input, the present embodiment can be understood as augmenting the text data with the information from PKG.

The “first” in the “first output result” is only used to illustrate that this output result is the output of the language model when the first data and the second data are input into the language model and does not have any other limiting effect.

In some embodiments, the first data and second data may be fed into the language model as one input.

In other words, there is only one input for the text information and the PKG information in the language model.

Optionally, the step 330 may include concatenating the first data and the second data, and inputting the concatenation into the language model to obtain the first output result.

The first data and second data may be concatenated before being input into the language model.

For example, the first data may be word embeddings and the second data may be PKG embeddings. The word embeddings (an example of the second embeddings) and the PKG embeddings (an example of the first embeddings) can be concatenated and then input to the language model.

The above does not limit the number of inputs for the language model. There may be more inputs in the language model, as long as one of them is used for text information and the PKG information.

In some embodiments, the first data and the second data may be fed into the language model as two separate inputs.

Optionally, the step 330 may include inputting the first data and the second data separately into the language model to obtain the first output result.

In other words, there are two inputs in the language model, one for the text information and the other for the PKG information.

For example, the first data may be word embeddings and the second data may be PKG embeddings. The word embeddings (an example of the second embeddings) and the PKG embeddings (an example of the first embeddings) may be input to the language model, respectively.

The above does not limit the number of inputs for the language model. There may be more inputs in the language model, as long as two of them are used for text information and the PKG information.

The above is only an example. Other ways to combine the text information and the PKG information can also be used in the embodiments of the present application.

According to the technical solutions in the embodiments of the present application, the information from the PKG of the same domain as the data to be processed can be used to enhance the performance of the language model. In other words, the information from the PKG can also be understood as used to augment the input for the language model. Probabilities for the facts in PKG smooth the information and may change depending on the task or context, which is beneficial to ensuring the accuracy of information in PKG in different scenarios, thereby improving the performance of the language model and ensuring the quality of NLP down-stream tasks.

The language model needs to utilize information to handle NLP tasks. Generally speaking, the more information a language model can utilize, the more accurate its results are. The information is typically encoded in the weights of the normal language model. Therefore, expanding the language model (e.g., improving model size or training data size) often leads to an improved performance on NLP down-stream tasks. However, this also increases the resource consumption.

According to the technical solutions in the embodiments of the present application, the information that the language model can use to output results is not only encoded in the language model's weights, but also stored in the PKG, which is an external structure. The externally stored information, namely the information in PKG, is beneficial for improving the quality of NLP down-stream tasks without increasing the size of the language model. Compared to language models that only include text data as input, the technical solutions in the embodiments of the present application may achieve better performance with a smaller language model size. In other words, the information in PKG not only helps to improve the overall performance of the language model, but also helps to reduce the size of the language model, thereby reducing resource consumption, such as the memory required for storing the model or computational resources required for inference.

Optionally, the method 300 may further include step 340 (not shown in FIG. 3).

Step 340, modify the PKG after obtaining the first output result.

Modifying the PKG may include at least one of the following: adding one or more new facts to the PKG, modifying one or more existing facts in the PKG, or removing one or more existing facts in the PKG.

Modifying an existing fact may include at least one of the following: modifying the probability of the existing fact, modifying the entity in the existing fact or modifying the relation in the existing fact.

In other words, modifying the PKG may include at least one of the following: adding an edge, removing an edge, modifying probability of an edge, adding a vertex, removing a vertex, or modifying a vertex.

The PKG may be modified to affect the behavior of the language model.

For example, in the inference stage, if the output result of the language model does not match expectations, the PKG may be modified in order to correct the output result.

In this way, the output can be adjusted without retraining the language model.

In some embodiments, the modification operation can be triggered by the user.

Optionally, the step 340 may include step 341 and step 342.

Step 341, obtain modification(s) to the PKG input that is through a public API.

Step 342, apply the modification(s) to the PKG.

The modification(s) may be input by the user. In other words, the user can edit fact(s) in the PKG.

PKG may be modified according to the user's need.

There may be a public API for editing facts in the PKG, which allows the user to modify the information in the PKG explicitly.

The modification(s) may be based on the output result of the language model. Or the modification(s) may be based on the task, context and other circumstances.

The output result of the language model can be analyzed. The user may modify the PKG to affect the language model's behavior in the desired way according to the analysis result.

Exemplarily, the analysis of the output result can be completed by the user. If the language model outputs an inconsistent answer from the user's point of view, the user may modify the PKG in order to correct the output or get the desired output.

For example, the user may check whether the PKG contains the relevant information or not. If there is relevant information, the user may increase or decrease the probability(s) of certain fact(s) related to the output. If there is no relevant information, the user may enhance the PKG with additional facts related to the output. The facts can be modified by querying for specific entity nodes given the starting node and edge corresponding to the relation.

Alternatively, the analysis of the output result can be automatically completed.

The specific analysis method can be set as needed. For example, if there is a significant difference between the output result and the pre-set expected result, it can be considered that the output result is incorrect and the analysis result can be provided to the user. Then the user can determine whether to modify the PKG or not according to the analysis result.

As an example, the analysis of the output result may be done by a monitoring system for the language model.

In some embodiments, the PKG may be modified automatically in active learning mode.

Optionally, the method may further include step 350 (not shown in FIG. 3).

Step 350, obtain a second output result based on the data, the modified PKG and the language model.

Step 350 may also be understood in the following way. The language model provides the second output result based on the information from the data to be processed and information from the modified PKG.

For ease of description, the information from the modified PKG may be referred to as third data. For example, the first data and the third data may be input into the language model to obtain the second output result.

The “third” in the “third data” is only used to illustrate that the third data is based on the modified PKG and does not have any other limiting effect.

The method of obtaining the third data can refer to the method of obtaining the second data mentioned earlier. The PKG is simply replaced with the modified PKG. It will not be repeated here. The modified PKG may also be called an updated PKG.

The “second” in the “second output result” is only used to illustrate that this output result is the output of the language model when the first data and the third data are input into the language model and does not have any other limiting effect.

The second output result may be different from the first output result.

Knowledge is not directly encoded in specific locations within the language model. This makes it impossible for specific information to be explicitly queried and therefore cannot be directly updated. For example, LLMs are trained on a huge amount of data. But these data are only a snapshot. Our world changes continuously and data used for training the language model may be outdated, which may result in incorrect output results. In order to update information in the model, it is necessary to continuously train the model with updated data.

According to the technical solutions in the embodiments of the present application, the modifications in PKG can be used for the language model's predictions. For example, the certain embeddings can be updated for the modifications in PKG and used for the language model's predictions. Information is stored explicitly in the PKG. It is relatively easy to find the needed information in PKG and validate it. In this way, the output from the language model can be controlled without retraining again. This greatly reduces the waiting time for users, which is beneficial for improving the user experience. At the same time, it is beneficial to avoid the large-scale occupation of resources caused by retraining.

For example, the updated information can be used for the language model's predictions, which is also beneficial for the language model to adapt to a changing world without retraining the model again.

For another example, the user may correct the results or get desired results without retraining the model again. The user may obtain new results with the same text data input from the language model almost immediately.

In addition, the language model may also be fine-tuned in background based on the modified PKG.

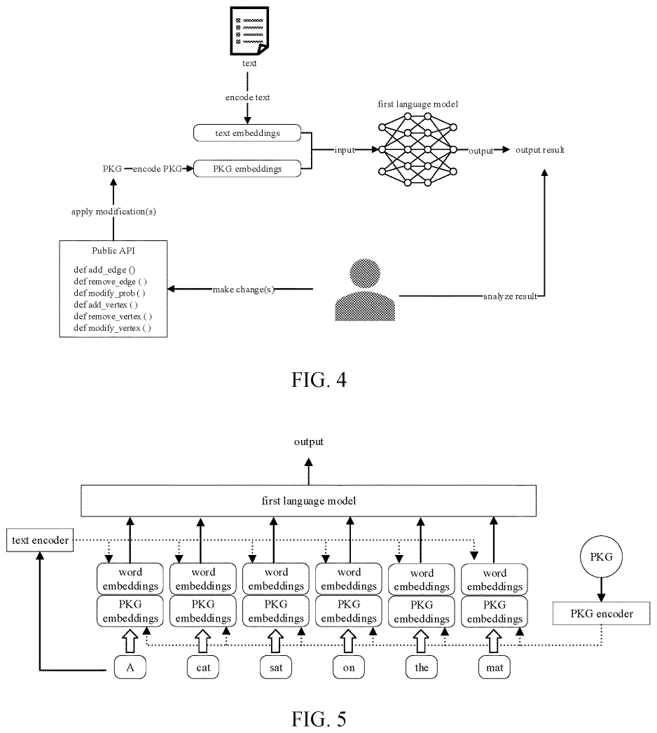

FIG. 4 is a schematic flowchart of an example method for data processing. The method 400 shown in FIG. 4 can be regarded as a specific implementation of method 300. The details in method 400 can refer to method 300. To avoid repetition, some descriptions may be omitted when describing method 400.

As shown in FIG. 4, the method 400 may include the following steps.

Step 410, obtain a text to be processed.

For example, the language model may be used for a machine translation task. A user may input a sentence as the text data. The text data may be the sentence “A cat sat on the mat” shown in FIG. 5. The language model in method 400 may be the first language model in FIG. 2.

Step 420, encode the text to obtain text embeddings (an example of the first data).

FIG. 5 is a schematic diagram of an example input for the first language model.

For example, as shown in FIG. 5, the text data may be encoded by the word embeddings model. Glove is taken as an example. The word embeddings obtained through Glove may also be called Glove embeddings.

Step 430, encode the PKG to obtain PKG embeddings (an example of the second data).

Step 440, input the word embeddings and the PKG embeddings to the first language model.

For example, as shown in FIG. 5, the word embeddings and the PKG embeddings may be concatenated before being input to the first language model.

Step 450, the first language model outputs result (an example of the first output result).

As mentioned before, the first language model may be used for a machine translation task. The result from the first language model may be a translation result of the text data.

Step 460, analyze the output result from the first language model.

For example, as shown in FIG. 4, the analysis may be completed by the user.

Step 470, apply modifications to the PKG.

For example, as shown in FIG. 4, public API may be provided for editing the PKG. The user may make changes to the PKG to affect the output of the first language model through the public API.

For example, as shown in FIG. 4, multiple API functions, namely add_edge( ), remove_edge( ), modify_prob( ), add_vertex( ), remove_vertex( ), and modify_vertex( ), are defined in the public API, and are used to add an edge, remove an edge, modify the probability of an edge, add a vertex, remove a vertex, and modify a vertex, separately.

After step 470, it is not necessary to retrain the first language model again. The certain PKG embeddings are updated for the modifications in PKG. The updated PKG embeddings may be used for the model's predictions. In this way, the user may obtain new result from the first language model almost immediately.

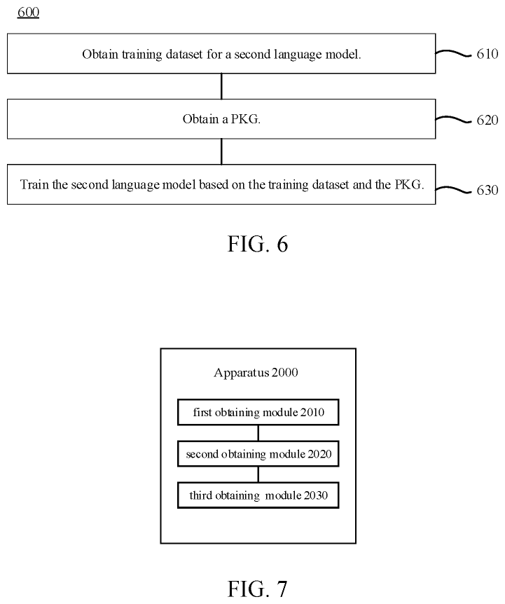

FIG. 6 is a schematic flowchart of a training method for a language model according to the embodiments of the present application. The method 600 can be applied to the language model training or pre-training.

Once the language model is trained, it can be used for inference, that is, for performing NLP tasks.

Exemplarily, method 600 may be used to obtain the language model in method 300, such as the first language model in FIG. 2, FIG. 4 or FIG. 5.

Alternatively, method 600 may also be used to fine-tune the language model in method 300. For example, after updating the PKG, the language model may be fine-tuned based on the updated PKG.

As shown in FIG. 6, method 600 may include the following steps.

Step 610, obtain training dataset for a second language model.

Step 620, obtain a PKG.

Step 630, train the second language model based on the training dataset and the PKG.

The second language model may be any one of the following: a language model to be trained or a language model to be pre-trained or a language model to be fine-tuned.

The “second” in the “second language model” is only used to illustrate that the second language model is a language model with parameters to be updated and does not have any other limiting effect.

As mentioned before, method 600 may be used to obtain the language model in method 300.

In one possible implementation, the language model in method 300 may be obtained by training the second language model through method 600. In this case, the language model in method 300 may be the trained second language model.

In another possible implementation, the language model in method 300 may be obtained based on the pre-trained second language model. In this case, the method 600 may be used for pre-training the second language model.

The training dataset may include one or more training samples. The form of training samples can be set as needed.

In one possible implementation, a training sample may include training text data.

In the training stage, the training text data may be fed into the second language model in the form of input required by the second language model.

For example, the training text data may be encoded before being fed into the second language model.

For another example, the training text data may be directly fed into the second language model.

In another possible implementation, a training sample may include encoding results of the training text data.

For example, the training sample may include word embeddings obtained by encoding the training text data.

The details about the training text data and encoding method may refer to the relevant description of the text data in method 300, and will not be repeated here.

The training dataset can be obtained in various ways. For example, the training dataset may be a publicly available training dataset or a training dataset constructed by users.

Step 620 can be achieved in various ways.

For example, obtaining a PKG may include creating a PKG from a raw source.

For another example, obtaining a PKG may include reading a pre-stored PKG.

For another example, obtaining a PKG may include receiving a PKG from other devices.

The details about the PKG can refer to method 300, and will not be repeated here.

In the training stage, the information from the PKG may be fed into the second language model in the form of input required by the second language model.

For example, data may need to be input into the second language model in a continuous representation. In this case, the PKG may be encoded before being fed into the second language model.

The details about the encoding method for the PKG may refer to the relevant description of the PKG in method 300, and will not be repeated here.

For another example, data may be input into the second language model in the form of a graph. In this case, one or more subgraphs of the PKG may be directly fed into the second language model.

In one possible implementation, there may be one input for the text information and the PKG information in the second language model.

For example, the training sample may include training text data. The training text data may be encoded into word embeddings. The PKG may be encoded into PKG embeddings. The word embeddings and the PKG embeddings can be concatenated and then input to the second language model.

In another possible implementation, there may be two inputs in the second language model, one for the text information and one for the PKG information.

For example, the training sample may include training text data. The training text data may be encoded into word embeddings. The PKG may be encoded into PKG embeddings. The word embeddings and the PKG embeddings can be input to the second language model as two separate inputs.

According to the technical solutions in the embodiments of the present application, the information from the PKG is used to augment the text input for the language model. Probabilities for the facts in PKG smooth the information and may change depending on the task or context, which is beneficial to ensuring the accuracy of information in PKG in different scenarios, thereby improving the performance of the language model and ensuring the quality of NLP down-stream tasks.

In addition, the PKG is used as additional information for language model training. The externally stored information, namely the information in PKG, not only helps to improve the performance of the language model, but also helps to reduce the size of the language model, thereby reducing resource consumption, such as the memory required for storing the model or computational resources required for training.

Table 1 shows the comparison results of the performance of multiple methods on the word-sense disambiguation task.

TABLE 1

| | Semeval2010 | | | Semeval2013 | | | | | | |
|---|---|---|---|---|---|---|---|---|---|---|
| | task 17 | | | task12 | | | Senseval2 | | | Avg |
| Methods | P | R | F1 | P | R | F1 | P | R | F1 | F1 |
| random | 27.6 | 25.1 | 26.3 | 33.4 | 28.8 | 30.9 | 45.4 | 42.2 | 43.7 | 33.7 |
| cosine similarity | 45.5 | 41.3 | 43.4 | 55.4 | 47.7 | 51.3 | 59.9 | 55.7 | 57.7 | 50.8 |
| LSTM | 46.8 | 42.5 | 44.6 | 60.9 | 52.4 | 56.3 | 72.4 | 67.4 | 69.8 | 57.0 |
| LSTM + KG | 44.9 | 40.8 | 42.7 | 60.1 | 51.7 | 55.6 | 70.6 | 65.7 | 68.1 | 55.6 |
| LSTM + PKG | 49.0 | 44.5 | 46.6 | 60.7 | 52.2 | 56.1 | 72.9 | 67.8 | 70.2 | 57.8 |
| LSTM (2 inputs) + | 53.1 | 48.3 | 50.6 | 61.6 | 53.0 | 57.0 | 71.5 | 66.6 | 69.0 | 58.9 |
| PKG | | | | | | | | | | |

Semeval2010 task 17, Semeval2013 task 12, Senseval2 are datasets annotated for the word-sense disambiguation task, which were used for the approaches testing. Semcor dataset was used for the models training.

Precision (P), recall (R), F1 score and average F1 score (Avg F1) have been considered performance evaluation indicators.

The performance of the random choice can be used to show the statistical significance of other approaches.

The method “cosine similarity” in table 1 refers to the choice based on cosine similarity.

The method “LSTM” in table 1 refers to a LSTM model which only uses Glove embeddings for the input text.

The method “LSTM+KG” in table 1 refers to a LSTM model which uses Glove embeddings concatenated with KG embeddings.

The method “LSTM+PKG” in table 1 refers to a LSTM model which uses Glove embeddings concatenated with PKG embeddings.

The method “LSTM (2 inputs)+PKG” in table 1 refers to a LSTM model with two inputs, where the first one is for Glove embeddings and the second one is for PKG embeddings.

As shown in table 1, compared with the method “LSTM”, the performance of the method “LSTM+KG” even slightly decreases, which means that adding the normal KG embeddings may even slightly decrease the quality of the down-stream task. The performance of the method “LSTM+KG” and the method “LSTM (2 inputs)+PKG” is generally higher than other methods, which means that considering the probabilities boosts the performance.

In addition, as shown in table 1, the performance of the method “LSTM (2 inputs)+PKG” is generally better than that of the method “LSTM+KG”, which means that the more complex the architecture, the better the results may be. Therefore, the idea may benefit from the more complex architectures.

As mentioned before, the technical solution in the embodiments of the present application may reduce resource consumption. Here are the comparison results of memory usage for three methods.

Bert-base-uncased model uses approximately 440 Mb in Python memory. Bert-large-uncased model uses approximately 1256 Mb in the Python memory. The technical solution in the embodiments of the present application uses approximately 212 Mb in the Python memory. It can be seen that the optimal storing the PKG in the Python allows to use less memory.

The method according to the embodiments of the present application is described in detail above, and the apparatus according to the embodiments of the present application will be described below with reference to FIGS. 7-10. The apparatus described below is capable of performing the methods described in the embodiments of the present application. For brevity, the repeated description is appropriately omitted when introducing the apparatus in the embodiments of the present application.

FIG. 7 is a schematic block diagram of an apparatus 2000 according to an embodiment of the present application. The apparatus 2000 shown in FIG. 7 may be used to perform the methods shown in FIG. 3, FIG. 4 or FIG. 6. As shown in FIG. 7, the apparatus 2000 includes a first obtaining module 2010 configured to obtain data from a user, a second obtaining module 2020 configured to obtain a probabilistic knowledge graph (PKG), where facts in the PKG are assigned with probabilities, and domain of the data is the same as domain of the PKG, and a third obtaining module 2030 configured to obtain a first output result based on the data, the PKG and a language model, where the language model is configured to perform an NLP task.

Optionally, the apparatus 2000 further includes a modification module (not shown in FIG. 7) configured to modify the PKG after obtaining the first output result.

Optionally, the modification module is configured to obtain a modification through a public application programming interface, and apply the modification to the PKG.

Optionally, the third obtaining module 2030 is further configured to obtain a second output result based on the data, a modified PKG and the language model.

Optionally, the apparatus 2000 further includes a first encoding module (not shown in FIG. 7) configured to encode one or more facts in the PKG to obtain first embeddings. The third obtaining module 2030 is configured to obtain the first output result based on the data, the first embeddings and the language model.

Optionally, the one or more facts are determined according to cosine similarity between strings from the data and entities in the PKG.

Optionally, the apparatus 2000 further includes a second encoding module (not shown in FIG. 7) configured to encode the data to obtain second embeddings. The third obtaining module 2030 is configured to concatenate the second embeddings and the first embeddings, and input the concatenated result into the language model to obtain the first output result, or input the second embeddings and the first embeddings separately into the language model to obtain the first output result.

The specific description can refer to the methods mentioned earlier, and will not be repeated here.

The term “module” herein may be implemented in software and/or hardware without specific limitation. For example, a “module” may be a software program, a hardware circuit, or a combination of the above functions. The third obtaining module 2030 is taken as an example. The implementation of the third obtaining module 2030 will be introduced. Similarly, the implementation of other modules can refer to the implementation of the third obtaining module 2030.

As an example of a software functional unit, the third obtaining module 2030 may include code running on a computing instance. The computing instance may include at least one of a physical host (computing device), a virtual machine, or a container. Furthermore, the above computing instance can be one or more. For example, the third obtaining module 2030 may include code running on multiple hosts/virtual machines/containers. Multiple hosts/virtual machines/containers used to run the code may be distributed in the same region or in different regions. Furthermore, multiple hosts/virtual machines/containers used to run the code may be distributed within the same availability zone (AZ) or across different AZs, each of which includes a data center or multiple geographically close data centers. Typically, a region may include multiple AZs.

Similarly, multiple hosts/virtual machines/containers used to run the code may be distributed within the same virtual private cloud (VPC) or across multiple VPCs. One VPC may be set within a region, and communication between two VPCs within the same region, as well as cross regional communication between VPCs from different regions, requires a communication gateway to be set up within each VPC to achieve interconnection between VPCs.

As an example of a hardware functional unit, the third obtaining module 2030 may include at least one computing device, such as a server, etc. Alternatively, the third obtaining module 2030 may also be a device implemented using application-specific integrated circuits (ASICs) or programmable logic devices (PLDs). The above mentioned PLD can be a complex PLD (CPLD), field-programmable gate array (FPGA), general array logic (GAL), or any combination thereof.

The third obtaining module 2030 includes multiple computing devices that can be distributed in the same region or in different regions. The third obtaining module 2030 includes multiple computing devices that can be distributed within the same AZ or across different AZs. Similarly, the third obtaining module 2030 includes multiple computing devices that can be distributed within the same VPC or across multiple VPCs. The multiple computing devices can be any combination of computing devices such as servers, ASICs, PLDs, CPLDs, FPGAs, and GALs.

In other embodiments, the third obtaining module 2030 can be used to execute any step in the method for data processing, the first obtaining module 2010 can be used to execute any step in the method for data processing, and the second obtaining module 2020 can be used to execute any step in the method for data processing. The steps responsible for implementing each module can be specified as needed, and different steps in the method for data processing can be implemented by each module to achieve all functions of the apparatus 2000.

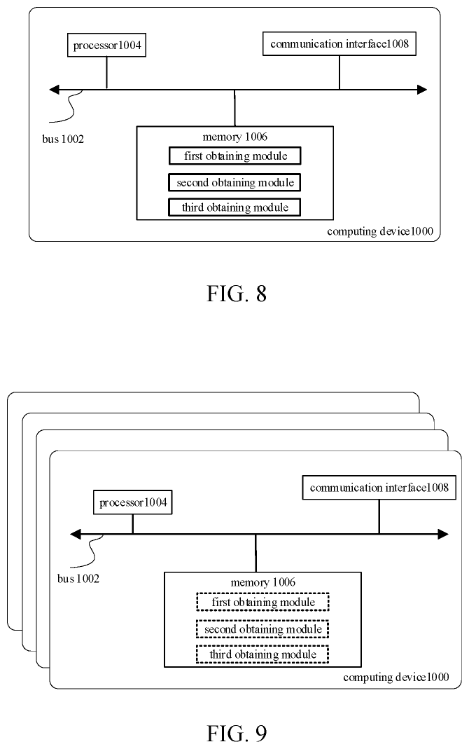

The present application also provides a computing device 1000. As shown in FIG. 8, the computing device 1000 includes bus 1002, processor 1004, memory 1006, and communication interface 1008. The processor 1004, memory 1006, and communication interface 1008 communicate through bus 1002. The computing device 1000 can be a server or terminal device. It should be understood that the present application does not limit the number of processors and memory in the computing device 1000.

Bus 1002 can be a Peripheral Component Interconnect (PCI) bus or an Extended Industry Standard Architecture (EISA) bus, etc. Buses can be divided into address buses, data buses, control buses, etc. For ease of representation, only one line is used in FIG. 8, but it does not mean that there is only one bus or one type of bus. Bus 1002 may include pathways for transmitting information between various components of computing device 1000 (such as memory 1006, processor 1004, communication interface 1008).

Processor 1004 may include any one or more of a central processing unit (CPU), graphics processing unit (GPU), microprocessor (MP), or digital signal processor (DSP).

Memory 1006 may include volatile memory, such as random-access memory (RAM). Processor 1004 may also include non-volatile memory, such as read-only memory (ROM), flash memory, hard disk drive (HDD), or solid-state drive (SSD).

Memory 1006 stores executable program code, and processor 1004 executes the executable program code to respectively implement the functions of the first obtaining module 2010, the second obtaining module 2020 and the third obtaining module 2030, thereby realizing the method for data processing. That is to say, instructions for executing the method for data processing are stored on memory 1006.

Communication interface 1008 uses transceiver modules such as but not limited to network interface cards and transceivers to achieve communication between computing device 1000 and other devices or communication networks.

The embodiment of the present application also provides a computing device cluster. The computing device cluster includes at least one computing device. The computing device can be a server, such as a central server, an edge server, or a local server in a local data center. In some embodiments, the computing device may also be a terminal device such as a desktop computer, laptop, or smartphone.

As shown in FIG. 9, the computing device cluster includes at least one computing device 1000. Memory 1006 in one or more computing devices 1000 in a computing device cluster may store the same instructions for executing the method for data processing.

In some possible implementations, memory 1006 of one or more computing devices 1000 in the computing device cluster may also store partial instructions for executing the method for data processing. In other words, a combination of one or more computing devices 1000 can jointly execute instructions for executing the method for data processing.

Memory 1006 in different computing devices 1000 in the computing device cluster can store different instructions, which are respectively used to execute some functions of the apparatus for data processing. That is to say, the instructions stored in memory 1006 of different computing devices 1000 may realize the functions of one or more modules in the first obtaining module 2010, the second obtaining module 2020 and the third obtaining module 2030.

In some possible implementations, one or more computing devices in a computing device cluster may be connected through a network. The network can be a wide area network, a local area network, or the like.

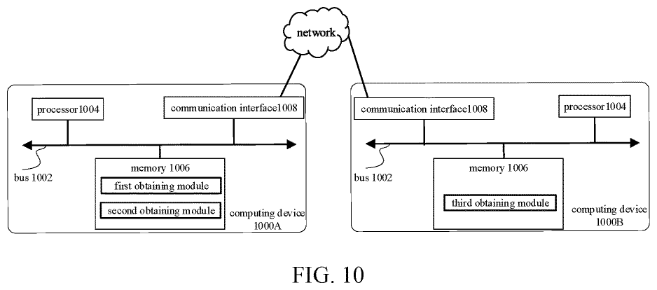

FIG. 10 illustrates a possible implementation. As shown in FIG. 10, two computing devices 1000A and 1000B are connected through a network. Further, computing devices 1000A and 1000B are connected to the network through communication interfaces in various computing devices. In the possible implementation, memory 1006 in the computing device 1000A stores instructions to execute the function of the first obtaining module 2010 and the second obtaining module 2020. Meanwhile, memory 1006 in computing device 1000B stores instructions to execute the functions of the third obtaining module 2030.

The connection method between the computing device clusters shown in FIG. 7 may take into account that the method for data processing provided in the present application may require data storage, and therefore consider entrusting the functions implemented by the third obtaining module 2030 to the computing device 1000B for execution.

The functions of the computing device 1000A shown in FIG. 7 can also be accomplished by multiple computing devices 1000. Similarly, the functions of computing device 1000B can also be accomplished by multiple computing devices 1000.

An embodiment of the present application further provides a computer program product. When the instructions are executed by a computing device cluster, the computing device cluster performs any of the foregoing methods.

An embodiment of the present application further provides a computer-readable storage medium, storing one or more instructions. When the one or more instructions are executed by a computing device cluster, the computing device cluster performs any of the foregoing methods.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of the present application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in the present application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit, or may be distributed among a plurality of network units. Some or all of the units may be selected based on actual requirements to achieve the objectives of the embodiments.

In addition, function units in the embodiments of the present application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of the present application may be implemented in the form of a software product. The software product is stored in a storage medium, and includes several instructions for instructing a computer device (which may be a personal computer, a server, a network device, or the like) to perform all or some of the steps of the methods described in the embodiments of the present application. The foregoing storage medium includes any medium that can store program code, such as a Universal Serial Bus (USB) flash drive, a removable hard disk, a ROM, a RAM, a magnetic disk, an optical disc or the like.

The foregoing descriptions are merely specific embodiments of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

1. A method, comprising:
obtaining data from a user;
obtaining a probabilistic knowledge graph (PKG), wherein the PKG comprises facts assigned with probabilities, and wherein a first domain of the data is the same as a second domain of the PKG; and
performing, based on the data, the PKG, and a language model, a natural language processing (NLP) task to obtain a first output result.

2. The method of claim 1, further comprising: modifying modifying the PKG after obtaining the first output result.

3. The method of claim 2, wherein modifying the PKG comprises:
obtaining a modification through a public application programming interface; and
applying the modification to the PKG.

4. The method of claim 2, further comprising obtaining a second output result based on the data, a modified version of the PKG, and the language model.

5. The method of claim 1, further comprising:
encoding one or more facts in the PKG to obtain first embeddings; and
further performing the NLP task based on the first embeddings.

6. The method of claim 5, the one or more facts are based on a cosine similarity between strings from the data and entities in the PKG.

7. The method of claim 5, further comprising encoding the data to obtain second embeddings, wherein performing the NLP task comprises:
concatenating the second embeddings and the first embeddings to obtain a concatenated result, and inputting the concatenated result into the language model to obtain the first output result; or
separately inputting the second embeddings and the first embeddings into the language model to obtain the first output result.

8. An apparatus comprising:
a memory configured to store instructions; and
one or more processors coupled to the memory, wherein when executed by the one or more processors, the instructions cause the apparatus to:
obtain data from a user;
obtain a probabilistic knowledge graph (PKG), wherein facts in the PKG comprises facts assigned with probabilities, and wherein a first domain of the data is the same as a second domain of the PKG; and
perform, based on the data, the PKG, and a language model, a natural language processing (NLP) task to obtain a first output result.

9. The apparatus of claim 8, wherein when executed by the one or more processors, the instructions further cause the apparatus to modify the PKG after obtaining the first output result.

10. The apparatus of claim 9, wherein when executed by the one or more processors, the instructions further cause the apparatus to further modify the PKG by:
obtaining a modification through a public application programming interface; and
applying the modification to the PKG.

11. The apparatus of claim 9, wherein when executed by the one or more processors, the instructions further cause the apparatus to perform the NLP task, based on the data, a modified version of the PKG, and the language model, to obtain a second output result.

12. The apparatus of claim 8, wherein when executed by the one or more processors, the instructions further cause the apparatus to:
encode one or more facts in the PKG to obtain first embeddings; and
further perform the NLP task based on the first embeddings.

13. The apparatus of claim 12, wherein the one or more facts are based on a cosine similarity between strings from the data and entities in the PKG.

14. The apparatus of claim 12, wherein when executed by the one or more processors, the instructions further cause the apparatus to:
encode the data to obtain second embeddings; and further perform the NLP task by:
concatenating the second embeddings and the first embeddings to obtain a concatenated result, and inputting the concatenated result into the language model to obtain the first output result; or
separately inputting the second embeddings and the first embeddings into the language model to obtain the first output result.

15. A computing device cluster comprising:
at least one computing device configured to:
obtain data from a user;
obtain a probabilistic knowledge graph (PKG), wherein facts in the PKG comprises facts assigned with probabilities, and wherein a first domain of the data is the same as a second domain of the PKG;
perform, based on the data, the PKG, and a language model, a natural language processing (NLP) task to obtain a first output result.

16. The computing device cluster of claim 15, wherein the at least one computing device is further configured to modify the PKG after obtaining the first output result.

17. The computing device cluster of claim 16, wherein the at least one computing device is further configured to further modify the PKG by:
obtaining a modification through a public application programming interface; and
applying the modification to the PKG.

18. The computing device cluster of claim 16, wherein the at least one computing device is further configured to obtain a second output result based on the data, a modified version of the PKG, and the language model.

19. The computing device cluster of claim 15, wherein the at least one computing device is further configured to:
encode one or more facts in the PKG to obtain first embeddings; and
further perform the NLP task the first embeddings.

20. The computing device cluster of claim 19, wherein the one or more facts are based on a cosine similarity between strings from the data and entities in the PKG.
